(19) United States
(12) Patent Application Publication
(10) Pub. No.: US 2016/0156052 A1
(43) Pub. Date: Jun. 2, 2016

(54) PROCESS FOR PREPARING AN ION-EXCHANGE COMPOSITE MATERIAL COMPRISING A POLYMER MATRIX AND A FILLER CONSISTING OF ION-EXCHANGE PARTICLES

(71) Applicants: COMMISSARIAT À L'ÉNERGIE ATOMIQUE ET AUX ÉNERGIES ALTERNATIVES, Paris (FR); ECOLE NATIONALE SUPÉRIEURE DE CHIMIE DE MONTPELLIER, Montpellier Cedex 5 (FR); INSTITUT NATIONAL DES SCIENCES APPLIQUEES, Villeurbanne (FR)

(72) Inventors: Bruno Ameduri, MONTPELLIER (FR); Jean-François Gerard, BRON (FR); Véronique Bounor Legare, LYON (FR); Sérigne Seck, SCHILTIGHEIM (FR); Pierrick Buvat, MONTBAZON (FR); Janick Bigarre, TOURS (FR)

(21) Appl. No.: 14/785,066

(22) PCT Filed: Apr. 22, 2014
(86) PCT No.: PCT/EP2014/058122

§ 371 Date: Oct. 16, 2015

(30) Foreign Application Priority Data
Apr. 23, 2013 (FR) 1353711

(51) Int. Cl. H01M 8/102

(52) U.S. Cl. CPC H01M 8/102; H01M 2008/1095

(57) ABSTRACT

The invention relates to a process for preparing a composite material comprising a fluorinated polymeric matrix and a filler consisting in ion exchange inorganic particles comprising a step for in situ synthesis of said particles within the polymeric matrix in the presence of a compatibilizing agent consisting in a copolymer comprising a first recurrent unit from the polymerization of a fluorinated ethylene monomer and a second recurrent unit from the polymerization of an optionally fluorinated (meth)acrylic monomer, said first recurrent unit being different from said second recurrent unit and said copolymer being different from (co)polymers entering the structure of the fluorinated polymeric matrix.

### TECHNICAL FIELD

The present invention relates to a process for preparing an ion-exchange composite material comprising a polymeric matrix and a filler consisting in ion exchange inorganic particles.

These materials prepared according to the method of the invention may find application in fields requiring an exchange of ions, as this is the case in the purification of effluents and in electrochemistry or in the fields of energy.

In particular, these composite materials may find their application in the design of fuel cell membranes, such as proton-conducting membranes for fuel cells operating with H₂/air or H₂/O₂ (these cells being known under the acronym of PEMFC for “proton exchange membrane fuel cell”) or operating with methanol/air (these cells being known under the acronym of DMFC for “direct methanol fuel cell”).

One of the general technical fields of the invention may thus be defined as being that of fuel cells and of proton-conducting membranes.

### STATE OF THE PRIOR ART

A fuel cell is an electrochemical generator, which converts the chemical energy of an oxidation reaction of a fuel in the presence of an oxidizer into electric energy, heat and water.

Generally, a fuel cell includes a plurality of electrochemical cells mounted in series, each cell comprising two electrodes with opposite polarity separated by a proton exchange membrane acting as a solid electrolyte.

The membrane ensures the passing towards the cathode of the protons formed during the oxidation of the fuel at the anode.

The membranes structure the core of the cell and therefore should have good performances as regards proton conduction as well as low permeability to the reactive gases (H₂/air or H₂/O₂ for PEMFC cells and methanol/air for DMFC cells). The properties of the materials making up the membranes are essentially heat stability, resistance to hydrolysis and to oxidation as well as some mechanical flexibility.

Currently used membranes and meeting these requirements are membranes obtained from polymers for example belonging to the family of polysulfones, polyetherketones, polyphenylenes, polybenzimidazoles. However, it was seen that these non-fluorinated polymers degrade relatively rapidly in fuel cell surroundings and their lifetime for the moment remains insufficient for the PEMFC application.

Membranes having more significant properties as regards lifetime are membranes obtained from polymers consisting of a perfluorinated linear main chain and of side chains bearing an acid group, such as sulfonic acid groups. Among the most widely known, mention may be made of membranes marketed under the name of NAFION® by Dupont de Nemours or under the name of Dow®, FLEMION® or Aciplex® by Dow Chemicals and Asahi Glass or further Aquivion® produced by Solvay. These membranes have good electrochemical performances and an interesting lifetime but nevertheless insufficient for PEMFC applications. Further, their cost (more than 300 euros/m²) remains prohibitive for marketing. For DMFC applications, they have a high permeability to methanol, which also limits their use with this type of fuel. Furthermore, the monomers making them up have a structure of the hydrophilic/hydrophobic type, which makes them particularly sensitive to hydration and dehydration phenomena. Thus, their operating temperature is typically located around 80° C., since beyond this temperature, hydration instabilities age the membranes prematurely.

In order to obtain long term efficiency as regards proton conduction at temperatures above 80° C., certain authors have focused their research on the design of more complex materials further comprising a polymeric matrix of proton-conducting particles, the conductivity thus not being entirely dedicated to the constitutive polymer(s) of the membranes. Consequently, it is thus possible to use a larger panel of polymers for entering the structure of the membrane.

Materials of this type may be composite materials comprising a polymeric matrix and a filler consisting in inorganic particles, such as clay particles, grafted with ion exchange groups.

Conventionally, these materials are prepared through two large synthesis routes: the route using a solvent and the route setting into play elements (in this case here, polymer and particles) in the molten state (subsequently called a molten route).

The route using a solvent consists of putting into contact the polymer and the inorganic particles in a solvent. The resulting mixture is then cast by coating on a substrate and then the solvent is left to evaporate.

This synthesis route has the advantage of being very simple to use and of not requiring any sophisticated apparatus. However, when it is intended to be applied on a large scale, this route poses difficulties in handling as to the volumes of solvent used and problems of safety inherent to the vapors of solvent which may be toxic or even carcinogenic. As to the obtained composite material, it is difficult to obtain proper density of the latter, notably related to the evaporation phenomenon of the solvent which generates a material structure which is difficult to control.

The molten route as for it consists in transforming precursor elements of the composite material (i.e., the polymer(s) and the particles) initially solid in a molten mixture. To do this, the particles are conventionally introduced by mechanical dispersion into the molten polymer. However, this technique, inter alia, has the problem of obtaining a fine and homogenous dispersion of the inorganic particles in the aforementioned polymer(s). The result of this is thus a material having non-uniform ion exchange properties, notably because of the concentration of particles by percolation at certain locations of the obtained final material.

Furthermore, whether this is via the solvent route or the molten route, it is difficult to obtain materials having a large proportion of ion exchange inorganic particles in the polymeric matrix.

Thus, there exists a real need for a novel process for preparing a composite material comprising, in a matrix, a dispersion of ion exchange inorganic particles, which for example may be applied for designing proton exchange membranes of a fuel cell, which would allow, inter alia:

obtaining in the resulting material, a homogenous distribution of the particles in the polymeric matrix and, thus, homogeneity as to the ion exchange properties;

obtaining, in the resulting material, when this is desired, significant proportions of ion exchange inorganic particles in the polymeric matrix.

### DISCUSSION OF THE INVENTION

In order to overcome the aforementioned drawbacks, the inventors developed an innovative and inventive process for synthesizing a composite material, for which the ion exchange properties are totally or partly imparted by inorganic particles.

Thus the invention relates to a process for preparing a composite material comprising a fluorinated polymeric matrix and a filler consisting in ion exchange inorganic particles comprising a step for synthesis in-situ of said particles within the polymeric matrix in the presence of a compatibilizing agent consisting in a copolymer comprising a first recurrent unit from the polymerization of a fluorinated ethylene monomer and a second recurrent unit from the polymerization of an optionally fluorinated (meth)acrylic monomer, said first recurrent unit being different from said second recurrent unit and said copolymer being different from the (co)polymer(s) entering the structure of the fluorinated polymeric matrix.

By proceeding in this way, one gets rid of the following drawbacks:

the mixing problems between the inorganic particles and the constitutive polymer(s) of the polymeric matrix;

the inhomogeneous distribution problems of these particles within the polymer(s);

the anisotropy problems as to the ion exchange properties encountered in the embodiments of the prior art, because of the mixing and distribution problems, notably when the particles are organized in macro-domains within the polymeric matrix, which does not give the possibility of ensuring a continuous path for proton transport,

these problems being solved by the fact that the particles are generated in-situ within the matrix in the presence of a compatibilizing agent as defined above, which allows these particles to be organized in micro-domains.

More specifically, the compatibilizing agent as defined above contributes to reducing the surface energy difference between the constitutive inorganic particles of the very hydrophilic inorganic phase by the presence of an optionally fluorinated (meth)acrylic recurrent unit and the polymeric matrix generally hydrophobic by the presence of said fluorinated ethylene recurrent unit.

Before entering more detail, the following definitions are specified.

By “synthesis step in-situ”, is meant a synthesis step carried out in the actual inside of the polymeric matrix, which in other words means that the inorganic particles do not pre-exist outside the polymeric matrix.

By “ion exchange inorganic particles” are meant inorganic particles at the surface of which are bound one or several ion exchange organic groups.

These may be oxide particles functionalized with ion exchange groups, such as silica particles functionalized with ion exchange groups.

The step for synthesis in-situ of the inorganic particles may be carried out with the sol-gel method, i.e. precursors of said particles undergo a hydrolysis-condensation operation in the actual inside of the material.

According to a first alternative, the synthesis step may comprise the following operations:

an operation for putting the constitutive polymer(s) of the matrix, said compatibilizing agent in contact with one or several precursors of the inorganic particles, said precursor(s) fitting the following formula (I):

(X)_{y-n}-M-(R)ₙ (I)

wherein:

* M is a metal element or a metalloid element;

* X is a hydrolyzable chemical group;

* R is an ion exchange chemical group or a precursor group of an ion exchange chemical group;

* y corresponds to the valency of element M; and

* n is an integer ranging from 0 to (y-1);

a hydrolysis-condensation operation of said precursor(s), in return for which inorganic particles resulting from the hydrolysis-condensation of said precursors are obtained;

in the case when R is a precursor group of an ion exchange chemical group, an operation for transforming the precursor group into an ion exchange chemical group or, in the case when n=0, an operation for functionalization of said particles with ion exchange chemical groups.

The hydrolysis-condensation operation may consist of heating the mixture from the contacting step at an effective temperature, for example at a temperature ranging from 150 to 300° C. for generating said hydrolysis-condensation operation, optionally in the presence of a catalyst.

The step for synthesis in-situ carried out according to the first alternative has the following advantages:

good miscibility between the precursors, the constitutive polymer(s) of the matrix and the compatibilizing agent(s) which finally gives the possibility, if desired, of accessing large proportions of inorganic particles in the matrix;

the absence of use of organic solvents, conventionally used in processes for preparing composite materials of the type of the invention, which gives the possibility of doing without recurrent toxicity and porosity problems inherent to the use of an organic solvent.

In order to avoid the use of a catalyst and the problems which may be generated by poor dispersion of this catalyst, during the contacting step, according to the invention, a proposal is made for achieving the step for synthesis in-situ of the inorganic particles, according to a second alternative, which step is carried out by a sol-gel method comprising the following operations:

an operation for hydrolysis of one or several precursors of inorganic particles of the following formula (I):

(X)_{y-n}-M-(R)ₙ (I)

wherein:

* M is a metal element or a metalloid element;

* X is a hydrolyzable chemical group;

* R is an ion exchange chemical group or a precursor group of an ion exchange chemical group;

* y corresponds to the valency of element M; and

* n is an integer ranging from 0 to (y-1);

an operation for putting the hydrolyzate obtained in the preceding step in contact with the constitutive polymer(s) of the matrix as well as with the compatibilizing agent as defined above;

an operation for heating the resulting mixture at an effective temperature for generating transformation of the hydrolyzate into inorganic particles;

in the case when R is a precursor group of an ion exchange chemical group, an operation for transforming the precursor group into an ion exchange chemical group or, in the case when n=0, an operation for functionalizing said particles with ion exchange chemical groups.

The aforementioned hydrolysis operation may consist of putting said precursors into contact with an aqueous acid solution optionally comprising one or several alcoholic solvents.

Thus, as an example, said precursors may be put into contact with an amount of water, so as to attain a molar ratio between the hydrolyzable functions of the precursors and the number of moles of water generally comprised between 0.001 and 1,000, preferably between 0.1 and 10.

The addition of water may, depending on the precursors used, lead to de-mixing of phases because of a miscibility problem between water and the precursors. Thus, it may be useful to add an alcoholic solvent in determined proportions (for example, methanol, ethanol, propanol), in order to improve the miscibility of the precursors in water. Generally, the alcoholic solvent may be added by observing a mass ratio with water ranging up to 100, in particular being comprised between 0 and 1. Furthermore, in order to activate hydrolysis, it may be advantageous to acidify the solution, so as to obtain a resulting solution advantageously having a pH of less than 2. This acidification may be achieved by adding to the solution an acid, such as hydrochloric acid, sulfuric acid, nitric acid or an organic acid, such as methanesulfonic acid.

Once the hydrolysis operation is carried out, the hydrolysate is added to the polymer(s) intended to form the polymeric matrix as well as to the compatibilizing agent followed by an operation for heating to an effective temperature for transforming the hydrolyzate into inorganic particles.

This temperature may easily be determined by one skilled in the art by performing tests at different temperatures until a temperature is found at which the hydrolyzate gives rise to inorganic particles.

Whether this is for the first alternative or the second alternative, the metal element M may be selected from a group formed with transition metals, lanthanide metals and so called post-transition metals of the columns IIIA and IVA of the Periodic Classification of the Elements. In particular, the transition metal element may be selected from Ti, V, Cr, Mn, Fe, Co, Ni, Cu, Zn, Y, Zr, Nb, Mo, Ru, Rh, Pd, Ag, Cd, Hf, Ta, W, Re, Os, Ir, Pt). In particular, the lanthanide element may be selected from La, Ce, Pr, Nd, Sm, Eu, Gd, Tb, Dy, Er, Yb. In particular, the post-transition metal element may be selected from the elements of column IIIA of the periodic classification, such as Al, Ga, In and Tl and the elements of the column IVA of the periodic classification, such as Ge, Sn and Pb.

The metalloid element M may be selected from Si, Se, Te.

Advantageously, M may be an element selected from Si, Ti and Al, in particular, Si.

The hydrolyzable group X should advantageously be a good leaving group during the hydrolysis-condensation operation mentioned above.

This group X may for example be a halogen atom, an acrylate group, an acetonate group, an alcoholate group of formula —OR′, a secondary or tertiary amine group, wherein R′ represents an alkyl group for example comprising from 1 to 10 carbon atoms, in particular, an ethyl group.

Preferably, X is a group —OR′ as defined above, or a halogen atom.

When the group R is an ion exchange chemical group, this may be a cation exchange chemical group (for example, a proton exchanger) or an anion exchange chemical group.

The group R may be a group of formula 13 R²—Z, wherein R² is a simple bond, a linear or branched alkylene group, comprising from 1 to 30 carbon atoms, preferably from 1 to 10 carbon atoms and optionally for which one or several hydrogen atoms are substituted with a halogen atom, such as fluorine or R² is a cyclic hydrocarbon group, and Z is an ion exchange chemical group.

In particular, when it is a cation exchange group, the group R may be a group of formula —R²—Z¹, wherein:

R² is a simple bond, a linear or branched alkylene group for example comprising from 1 to 30 carbon atoms, preferably from 1 to 10 carbon atoms and optionally for which one or several hydrogen atoms are substituted with a halogen atom, such as fluorine, or R² is a cyclic hydrocarbon group, such as an aromatic or heterocyclic group;

Z¹ is a group —SO₃H, —PO₃H₂, —CO₂H, optionally as salts.

It is specified that by salt, is conventionally meant a group —SO₃X, —PO₃X₂ or —CO₂X wherein X represents a cation.

As an example, R² may be a perfluoroalkylene group, such as a group —CF₂—.

When it is an anion exchange group, the group R may be a group of formula —R²—Z², wherein:

R² is a simple bond, a linear or branched alkylene group, for example comprising from 1 to 30 carbon atoms, preferably from 1 to 10 carbon atoms and optionally for which one or several hydrogen atoms are substituted with a halogen atom, such as fluorine or R² is a cyclic hydrocarbon group, such as an aromatic or heterocyclic group;

Z² is an amine group, optionally as a salt (in which case this may be referred to as an ammonium group), a phosphonium group or a sulfonium group.

It is specified that, by phosphonium group is conventionally meant a group comprising a positively charged phosphorus atom, this group may originate from the reaction of a phosphine compound (such as triphenylphosphine) with an alkyl halide or a benzyl alcohol.

It is specified that by a sulfonium group, is conventionally meant a group comprising a positively charged sulfur atom, this group may originate from a reaction of a thioester compound with an alkyl halide.

As an example, R² may be a perfluoroalkylene group, such as a group —CF₂—.

It is specified above that group R may also be a precursor chemical group of an ion exchange group.

By precursor chemical group of an ion exchange group, is conventionally meant a group capable of being transformed by a suitable chemical reaction into said ion exchange group.

Such a group R may be a group of formula —R²—Z³, wherein:

R² is a simple bond, a linear or branched alkylene group, for example comprising from 1 to 30 carbon atoms, preferably from 1 to 10 carbon atoms and optionally for which one or several hydrogen atoms are substituted with a halogen atom, such as fluorine or R² is a cyclic hydrocarbon group, for example an aromatic or heterocyclic group;

Z³ is a precursor group of a group Z¹ or Z² such mentioned above.

As an example, R² may be a perfluoroalkylene group, such as a group —CF₂—.

When a precursor of this type (i.e. a precursor comprising a precursor group of an ion exchange group) is used, it is necessary to engage an operation for transforming the precursor group into an ion exchange chemical group.

Thus, when the group Z¹ is a group —SO₃H optionally as a salt, the group —Z³ may be a thiol group —SH, which will undergo a transformation operation consisting of subjecting it to oxidation with hydrogen peroxide followed by acidification with concentrated sulfuric acid.

When the group Z¹ is a group —CO₂H optionally as a salt, the group —Z³ may be an ester group or an acid chloride group which may be transformed into a —CO₂H group optionally as a salt by hydrolysis.

The aforementioned precursors may advantageously be alkoxysilanes or halogenosilanes (in which case M is Si and X is a group —OR′ or a halogen atom) comprising at least one group R as defined above.

Precursors fitting this specificity may thus be precursors fitting the following formula (II):

(OR′)₄₋ₙ—Si—(R)ₙ (II)

wherein:

R′ is as defined above;

R corresponds to the formula —R²—Z³, R² being a linear or branched alkylene group, comprising from 1 to 30 carbon atoms, preferably from 1 to 10 carbon atoms, and optionally for which one or several hydrogen atoms are substituted with a halogen atom, such as fluorine and Z³ being a precursor group of a group Z′ or a group Z² as mentioned above;

n is an integer ranging from 1 to 3.

For example, Z³ may be a thiol group.

As an example, mention may be made of mercaptopropyltriethoxysilane of formula HS—(CH₂)₃—Si(OCH₂CH₃)₃.

When, for the aforementioned precursors, n is equal to 0, it is necessary at the end of the process to carry out an operation for functionalizing said particles by introducing on said particles ion exchange chemical groups.

The suitable functionalization reactions will be selected by one skilled in the art depending on the obtained and desired material. This may for example be substitution reactions on aromatic rings, additional reactions on unsaturated bonds, oxidation reactions of oxidizable groups, the result of these reactions having the consequence of grafting by covalence to the particles of ion exchange groups.

The aforementioned precursors, regardless of the alternative used, and in particular for the second alternative, may be used in combination with a pre-condensate comprising recurrent units of the following formula (III):

M(X)_{y-2} (III)

wherein:

M is a metal or metalloid element as defined above;

X is a group as defined above;

y corresponds to the valency of the metal or metalloid element.

In particular, X may correspond to a group —OR′ with R′ being as defined above.

As an example, this may thus be a pre-condensate of dimethoxysilane comprising the recurrent units of the following formula (IV):

Si(OCH₃)₂ (IV)

Pre-condensates may give the possibility of ensuring the structuration of the inorganic particles, for example by increasing their cohesion.

The mass levels between the aforementioned precursors and the pre-condensates will be adapted so as to obtain the best compromise between structuration and functionalization.

As an example, the mass ratio (precursor/pre-condensate) may be comprised between 0.01 and 50 and more generally between 0.1 and 20.

Regardless of the applied embodiment, the constitutive polymer(s) of the matrix is (are), advantageously, hot-melt polymers, in particular when the synthesis step is carried out by extrusion. For example, the polymers may advantageously have a glassy transition temperature or a melting temperature conventionally ranging from 100 to 350° C.

In particular, the polymer(s) intended to make up the matrix may be selected from among thermoplastic polymers, such as fluorinated thermoplastic polymers.

These may notably be fluorinated thermoplastic polymers not exchanging ions, such as a (co)polymer comprising at least one type of recurrent units from a fluorinated monomer, for example, polytetrafluoroethylenes (known under the acronym of PTFE), polyvinylidene fluorides (known under the acronym of PVDF), fluorinated ethylene-propylene copolymers (known under the acronym of FEP), copolymers of ethylene and tetrafluoroethylene (known under the acronym of ETFE) or such as a copolymer comprising at least two types of recurrent units from fluorinated monomers, for example a copolymer of vinylidene fluoride and hexafluoropropene (known under the acronym of PVDF-HFP), and mixtures thereof.

These may also be fluorinated ion exchange thermoplastic polymers, such as perfluorinated sulfonated polymers. It is specified that by perfluorinated sulfonated polymers are meant polymers comprising a perfluorinated linear main chain and side chains bearing sulfonic acid groups. Such polymers are notably available commercially under the trade name NAFION® by Dupont de Nemours, or ACIPLEX-S® from Asahi Chemical, or further Aquivion® from Solvay.

The fluorinated polymers, because of the presence of stable —C—F bonds (with a binding energy of 485 kJ/mol), form polymers having excellent properties and characteristics, such as anti-adherence, abrasion resistance, corrosion resistance, resistance to chemical etchings and to temperature.

Advantageously, the method of the invention may be applied with a polymer of the PVDF-HFP type interesting for the stability of its fluorinated backbone, its low production cost.

The mass ratio of the aforementioned precursors (optionally in combination with at least one pre-condensate as defined above) relatively to the constitutive polymer(s) of the matrix may range up to 80%, advantageously from 5 to 50%.

The compatibilizing agents as mentioned above consist in a copolymer comprising a first recurrent unit from the polymerization of a fluorinated ethylene monomer and of a second recurrent unit from the polymerization of an optionally fluorinated (meth)acrylic monomer.

More specifically, the first recurrent unit may fit the following formula (V):

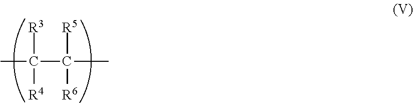

wherein R³, R⁴, R⁵ and R⁶ represent, independently of each other, a hydrogen atom, a halogen atom, a perfluoroalkyl group or a perfluoroalkoxy group, provided that at least one of the groups R³ to R⁶ represents a fluorine atom, a perfluoroalkyl group or a perfluoroalkoxy group, in which case the fluorinated ethylene monomer allowing this recurrent unit to be obtained is a monomer of the following formula (VI):

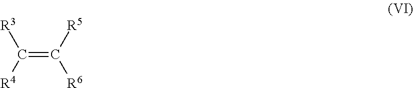

R³ to R⁶ being as defined above.

By perfluoroalkyl group is conventionally meant, in the foregoing and in the following, an alkyl group for which all the hydrogen atoms are replaced with fluorine atoms, this group fitting the formula —CₙF₂ₙ₊₁, n corresponding to the number of carbon atoms, this number may range from 1 to 5, such a group may be a group of formula —CF₃.

By perfluoroalkoxy group, is conventionally meant in the foregoing and in the following, an —O-alkyl group for which all the hydrogen atoms are replaced with fluorine atoms, this group fitting the formula —O—CₙF₂ₙ₊₁, n corresponding to the number of carbon atoms, this number may range from 1 to 5, such a group may be a group of formula —O—CF₃.

Thus, a particular recurrent unit covered by the general definition of the recurrent units of formula (V) may correspond to a recurrent unit of the following formula (VII):

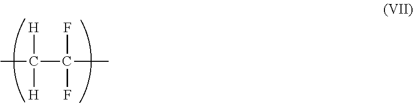

in return for which the monomer, from which stems this recurrent unit, fits the following formula (VIII):

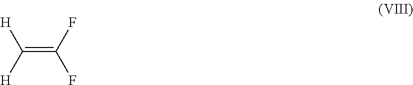

this monomer being known as vinylidene fluoride (known under the acronym of VDF).

Other particular recurrent units covered by the general definition of the recurrent units of formula (V) may correspond to the following particular units:

a recurrent unit for which R³, R⁴ and R⁶ are fluorine atoms and R⁵ is a chlorine or bromine atom, in which case the monomer, from which stems this recurrent unit, is chlorotrifluoroethylene (known under the acronym of CTFE) or bromotrifluoroethylene;

a recurrent unit for which R³, R⁵ and R⁶ are fluorine atoms and R⁴ is a group —CF₃, in which case the monomer, from which this recurrent unit stems, is hexafluoropropylene (known under the acronym of HFP);

a recurrent unit for which R³, R⁴ and R⁵ are fluorine atoms and R⁶ is a hydrogen atom, in which case the monomer, from which stems this recurrent unit, is trifluoroethylene (known under the acronym of TrFE);

a recurrent unit for which R³ to R⁶ are fluorine atoms, in which case the monomer, from which stems this recurrent unit, is tetrafluoroethylene (known under the acronym of TFE);

a recurrent unit for which R³ to R⁵ are fluorine atoms and R⁶ is an —OCF₃group;

a recurrent unit for which R³ to R⁵ are hydrogen atoms and R⁶ is a fluorine atom;

a recurrent unit for which R³ to R⁵ are hydrogen atoms and R⁶ is a —CF₃group;

a recurrent unit for which R³ and R⁵ are fluorine atoms and R⁴ and R⁶ are chlorine atoms;

a recurrent unit for which R³ and R⁴ are fluorine atoms, R⁵ is a hydrogen atom and R⁶ is a bromine atom.

More specifically, the second recurrent unit may fit the following formula (IX):

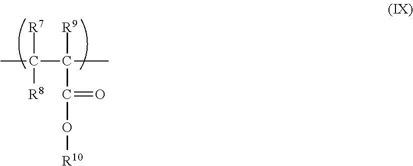

wherein:

R⁷ and R⁸ represent, independently of each other, a hydrogen atom, a halogen atom;

R⁹ represents a perfluoroalkyl group; and

R¹⁰ represents a hydrogen atom or a cationic counter-ion.

By cationic counter-ion is conventionally meant a cation capable of neutralizing the negative charge borne by the —COO⁻ group, this cationic counter-ion may be selected from cations from alkaline elements, ammonium cations.

Thus, a particular recurrent unit covered by the general definition of the recurrent units of formula (IX) may correspond to a recurrent unit of the following formula (X):

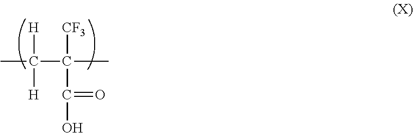

in return for which the monomer, from which stems this recurrent unit, fits the following formula (XI):

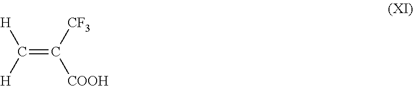

this monomer being known as 2-trifluoromethacrylic acid.

A specific compatibilizing agent compliant with the definition of the invention is a copolymer comprising as a first recurrent unit, a recurrent unit of formula (VII) and comprising, as a second recurrent unit, a recurrent unit of formula (X).

Within such a copolymer, the molar ratio between the first recurrent unit and the second recurrent unit may be comprised between 50/50 and 99.9/0.1 and more particularly between 55/45 and 90/10.

The constitutive copolymer of the compatibilizing agent may have a molar mass comprised between 1,000 and 1,000,000 g/mol, and more advantageously between 4,000 and 100,000 g/mol.

The compatibilizing agent may be comprised, in the mixture in which takes place the step in-situ, in a content ranging from 0.1 to 20% by mass, preferably 3 to 10% by mass based on the total mass of the polymer(s) intended to enter the structure of the fluorinated polymeric matrix.

These compatibilizing agents may be prepared beforehand with a radical copolymerization step involving at least two types of distinct monomers (at least one fluorinated ethylene monomer and at least one fluorinated (meth)acrylic monomer) and at least one polymerization initiator.

Said initiator may be tert-butyl-cyclohexylperoxydicarbonate, which may be comprised between 0.01% and 2% by mass based on the total mass of the monomers and, preferably between 0.05% and 1%.

The step for synthesizing in-situ the particles may be carried out, advantageously, by extrusion of the polymer(s) intended to form the matrix, of the compatibilizing agent and of the aforementioned precursors or of the hydrolyzate, optionally in presence of an pre-condensate, which means that the contacting operation and the heating operation (according to the first alternative and the second alternative) take place within an extruder, the other operations may be carried out outside the extruder.

Thus, in this scenario, the constitutive polymer(s), the compatibilizing agent(s), and the precursors or the hydrolyzate, optionally in the presence of a pre-condensate as defined above, are preferably introduced simultaneously through at least one inlet of an extruder, where they are mixed intimately (which is the aforementioned contacting step). The polymer(s) may be introduced as powders, shavings or granules, the latter form being the preferred form for reasons of handling and supplying ease. The thereby formed mixture then migrates into the extruder until it reaches the end of the latter.

The formation of the inorganic particles via the precursors or the hydrolyzate is achieved and the mixture dwells in the extruder by heating according to a particular temperature profile, so that the characteristic hydrolysis-condensation reactions of the sol-gel process notably are triggered. This may thus be referred to as a reactive extrusion.

The operating conditions of the extrusion, such as the screw profile, the dwelling time of the mixture, the rotary speed of the screw will be set by one skilled in the art depending on the desired morphology of the final material and on the sought dispersion of inorganic particles in the polymeric matrix.

As an example, the extrusion may be advantageously achieved with the following operating conditions:

a screw profile of the co-rotary interpenetrated twin screw;

a dwelling time of the aforementioned mixture comprised between 0.1 minutes and 120 minutes, preferably from 2 to 30 minutes;

a speed of rotation of the screw comprised between 5 and 1,000 revolutions/minute, preferably between 50 and 200 revolutions/min;

a mixture temperature ranging from 150 to 350° C., preferably from 180 to 250° C.

The extruder may be equipped with a flat die giving the possibility of obtaining films which may have a thickness ranging from 5 to 500 μm or further with a so-called “ring die” giving the possibility of obtaining rings or optionally granules, if the rings are brought to be cut.

As an example, a particular process of the invention consists in a process for synthesizing a composite material comprising a polymeric matrix and a filler consisting in oxide particles, such as silica, comprising ion exchange groups of formula —R²—Z¹ as defined above comprising the following operations:

an operation for putting into an extruder one or several fluorinated constitutive polymers of the polymeric matrix, of a compatibilizing agent according to the invention (for example, a compatibilizing agent consisting in a copolymer comprising a first recurrent unit of formula (VII) and a second recurrent unit of formula (X)) in contact with one or several precursors of the aforementioned inorganic particles, said precursor(s) fitting the following formula (I):

(X)_{y-n}-M-(R)ₙ (I)

wherein:

* M is a metal element or a metalloid element;

* X is a hydrolyzable chemical group;

* R is a group of formula —R²—Z³ as defined above;

* y corresponds to the valency of group M; and

* n is a integer ranging from 0 to (y-1);

said precursor(s) being used in association with a pre-condensate of the following formula (III):

M(X)_{y-2} (III)

M, X and y being as defined above;

a hydrolysis-condensation operation, in the extruder of said precursor(s) in association with said pre-condensate, in return for which inorganic particles resulting from the hydrolysis-condensation of said precursors and of said pre-condensate are obtained;

an operation for transforming the aforementioned group Z³ into an ion exchange chemical group Z¹.

For example, the precursor may be a precursor of the following formula (II):

(OR′)₄₋ₙ—Si—(R)ₙ (II)

wherein:

R′ is as defined above;

R corresponds to the formula —R²—Z³, R² is an alkylene group comprising from 1 to 30 carbon atoms, preferably from 1 to 10 carbon atoms, and optionally for which one or several hydrogen atoms are substituted with a halogen atom, such as fluorine and Z³ is a precursor group of a group Z¹ as mentioned above;

n is a integer ranging from 1 to 3.

A precursor fitting this definition given above may be mercaptopropyltriethoxysilane of formula HS—(CH₂)₃—Si(OCH₂CH₃)₃ and the pre-condensate is a pre-condensate for which M is Si and X is an —OR′ group, R′ being as defined above, such as a pre-condensate of the polytetramethoxysilane type.

The fluorinated polymer may be a copolymer of vinylidene fluoride and hexafluoropropene.

As an example, a particular process of the invention consists in a process for synthesizing a composite material comprising a polymeric matrix and a filler consisting in oxide particles, such as silica, comprising ion exchange groups of formula —R²—Z¹ as defined above, comprising the following operations:

an operation for hydrolysis of one or several precursors of the inorganic particles of the following formula (I):

(X)_{y-n}-M-(R)ₙ (I)

* M is a metal element or a metalloid element;

* X is a hydrolyzable chemical group;

* R is a group of formula —R²—Z³ as defined above;

* y corresponds to the valency of group M; and

* n is an integer ranging from 0 to (y-1);

said precursor(s) being used in association with a pre-condensate of the following formula (III):

M(X)_{y-2} (III)

M, X and y are as defined above;

an operation for putting into an extruder the hydrolyzate obtained in the preceding step in contact with one or several fluorinated polymers intended to enter the structure of the matrix and at least one compatibilizing agent according to the invention (for example, a compatibilizing agent consisting in a copolymer comprising a first recurrent unit of formula (VII) and a second recurrent unit of formula (X));

an operation for heating the resulting mixture to an effective temperature for generating transformation of the hydrolyzate into inorganic particles;

an operation for transforming the aforementioned group Z³ into an ion exchange chemical group Z¹.

For example, the precursor may be a precursor of the following formula (II):

(OR′)₄₋ₙ—Si—(R)ₙ (II)

wherein:

R′ is as defined above;

R corresponds to the formula —R²—Z³, R² being an alkylene group comprising from 1 to 30 carbon atoms, preferably from 1 to 10 carbon atoms, and optionally for which one or several hydrogen atoms are substituted with a halogen atom, such as fluorine and Z³ is a precursor group of a group Z¹ as mentioned above;

n is an integer ranging from 1 to 3.

A precursor fitting this definition given above may be mercaptopropyltriethoxysilane of formula HS—(CH₂)₃—Si(OCH₂CH₃)₃ and the pre-condensate is a pre-condensate, for which M is Si and X is a group of formula —OR′, R′ being as defined above, such as a pre-condensate of the polytetramethoxysilane type.

The fluorinated polymer may be a copolymer of vinylidene fluoride and of hexafluoropropene.

The materials obtained according to the invention may appear in different shapes, such as films, rings, granules.

These materials because of the characteristics of the process, may have the following advantages:

if desired, a large proportion of ion exchange inorganic particles in the polymeric matrix (for example a proportion which may be greater than 40% by mass), thereby giving the possibility of attaining excellent ion exchange properties which no longer depend on the selection of the polymer(s);

a homogenous material as to the distribution of said particles within the material and thus homogenous ion exchange properties within this material;

a material for which the mechanical properties of the matrix are not at all diminished by the presence of the inorganic particles, which may explain, without being bound by theory, that the particles are not organized in percolated domains because they are produced in-situ in the actual inside of the matrix.

These materials may be defined, according to the invention, as composite materials comprising a fluorinated polymeric matrix, at least one compatibilizing agent as defined above and a filler consisting in ion exchange inorganic particles.

The characteristics relating to the polymeric matrix, the compatibilizing agent and the ion exchange inorganic particles outlined in the process may be repeated for taking into account the materials as such.

More specifically, a material according to the invention may be a material for which:

the polymeric matrix is a matrix in a copolymer of vinylidene fluoride and of hexafluoropropene;

a compatibilizing agent consisting in a copolymer comprising a first recurrent unit of formula (VII) and a second recurrent unit of formula (X);

silica particles functionalized with proton conducting groups of formula —(CH₂)₃—SO₃H.

The process of the invention as well as the materials of the invention may be applied to large fields of application, from the moment that these fields involve the use of ion exchange materials.

Thus, the process of the invention and the materials of the invention may for example be applied to the following fields:

* the field of electrochemistry, such as:

fuel cells, for example fuel cells operating with H₂/air or H₂/O₂ (known under the acronym of PEMFC for “proton exchange membrane fuel cell”) or operating with methanol/air (known under the acronym of DMFC for “direct methanol fuel cell”), said materials designed by this process may enter the structure of proton exchange membranes;

lithium batteries, said materials designed with this process may enter the structure of the electrolytes;

* the field of purification, such as treatment of effluents; and

* the field of electrochromism.

Thus, the process of the invention and the materials of the invention may be intended for preparing fuel cell membranes, intended to be inserted into a fuel cell device within an electrode-membrane-electrode assembly.

These membranes advantageously appear as thin films, for example having a thickness from 20 to 200 micrometers.

In order to prepare such an assembly, the membrane may be placed between two electrodes, for example in fabric or in a carbon paper impregnated with a catalyst. The assembly formed with the membrane positioned between both electrodes is then pressed at an adequate temperature in order to obtain good electrode-membrane adhesion.

The electrode-membrane-electrode assembly is then placed between two plates ensuring electric conduction and supply of reagents to the electrodes. These plates are commonly designated by the term of bipolar plates.

The invention will now be described with reference to the following examples given as an illustration and not as a limitation.

### SHORT DESCRIPTION OF THE DRAWINGS

FIGS. 1 to 3 represent photographs taken with an electron microscope of three examples of materials prepared according to an embodiment of the invention discussed in Example 4.

FIG. 4 illustrates a photograph taken with an electron microscope of a material non-compliant with the invention, the preparation of which is discussed in example 4.

### DETAILED DISCUSSION OF PARTICULAR EMBODIMENTS

### EXAMPLE 1

This example illustrates the preparation of a compatibilizing agent used within the scope of the process of the invention, i.e. a copolymer from radical copolymerization of vinylidene fluoride (symbolized by the acronym VDF) and of 2-trifluoromethacrylic acid (symbolized by the acronym MAF).

Because of the gaseous state of VDF, the copolymerization is carried out in an autoclave of 100 mL Parr Hastelloy equipped with a pressure gauge, a rupture disc and valves for introducing gas and for discharging. Further, a regulated electronic device controls both the stirring and the heating of the autoclave. Before introducing the reagents, the autoclave is pressurized to 30 bars of nitrogen for 1 hour in order to check its airtightness. Once the nitrogen is discharged, the reactor is placed in vacuo for 40 minutes, and then 2-trifluoromethacrylic acid (13.71 g; 0.0978 mol), bis-cyclohexyl-tert-butyl peroxydicarbonate (2.951 g, 7.41 mmol), 30 mL of 1,1,1,3,3-pentafluorobutane and 30 mL of acetonitrile are introduced therein. The autoclave is then cooled to −20° C. by means of an acetone/liquid nitrogen mixture and then the VDF (27 g; 0.422 mol) is then introduced therein. The autoclave is then gradually heated up to 60° C. and the time-dependent change of the pressure and temperature are recorded. During copolymerization, an increase in the pressure inside the reactor is observed (26 bars) due to the exothermic nature of the reaction (70° C.) and then a reduction of the latter caused by the conversion of the VDF in the copolymer in solution. During the hour subsequent to this exothermic phenomenon, the pressure passed from 26 bars to 5 bars with a temperature maintained at 60° C. After reaction and cooling, the autoclave is left in the ice for 30 minutes and then degassed. The conversion of the VDF is calculated by the coefficient (m-δm)/m, wherein m and δm respectively designate the initial VDF masses and the mass difference of the autoclave before and after degassing (when δm=0, this means that the VDF conversion rate is 100%). The autoclave is degassed (in order to release the unreacted VDF) and the VDF conversion rate was determined by double weighing (65%). After opening the autoclave, the solvents are distilled and the crude product is then precipitated from 2 liters of cold pentane. The obtained product is filtered and then dried for 24 hours at 60° C., in return for which 33.1 g of the copolymer mentioned above are obtained and which is called a poly(VDF-co-MAF) copolymer (or more succinctly, YP1 copolymer), this copolymer being characterized by NMR spectroscopy. It appears as a white powder comprising 55% by mole of VDF and 45% by mole of MAF.

### EXAMPLE 2

The same process is carried out with a 600 mL autoclave from 65.24 g (0.46 mol) of MAF, 18.1 g (45 mmol) of bis-cyclohexyl-tert-butyl peroxydicarbonate, 200 mL of 1,1,1,3,3-pentafluorobutane and 200 mL of acetonitrile. After inserting VDF (162 g, 2.52 mol), the autoclave is gradually heated up to 60° C. and the temperature is maintained for 12 hours. Like in Example 1, an exotherm is observed up to about 95° C. inducing a rise in pressure up to 54 bars, and then after about 3 hours, a reduction in pressure to 10 bars. After reaction and cooling, the autoclave is cooled and then degassed (a loss of 32 g corresponding to 80% VDF conversion). It appears as a white powder (176.4 g; 78%) comprising 69% by mole of VDF and 31% by mole of MAF. This copolymer is called a poly(VDF-co-MAF) copolymer (or more succinctly, a YP2 copolymer).

### EXAMPLE 3

The same process is carried out with a 100 mL autoclave from 3.63 g (0.026 mol) of MAF, 2.95 g (7.41 mmol) of bis-cyclohexyl-tert-butyl peroxydicarbonate, 50 mL of 1,1,1,3,3-pentafluorobutane, 30 mL of acetonitrile and 40 mL of degassed deionized water. After insertion of VDF (32 g, 0.50 mol), the autoclave is gradually heated up to 60° C. and the temperature is maintained for 12 hours. Like in Example 1, an exotherm is observed up to about 85° C. inducing a rise in pressure up to 50 bars followed by a reduction in pressure to 24 bars. After reaction and cooling, the autoclave is cooled and then degassed (a loss of 6 g corresponding to 81% conversion of VDF). It appears as a white powder (28.1 g; 79%) comprising 87% by mole of VDF and 13% by mole of MAF. This copolymer is designated as poly(VDF-co-MAF) copolymer (or more succinctly, a YP3 copolymer).

### EXAMPLE 4

This step illustrates the preparation of various materials according to the invention including, before introduction into the extruder, a step for pre-hydrolysis of the precursors, the preparation methods of which are mentioned in the examples above.

The general operating procedure of this pre-hydrolysis step is the following.

x g of ethanol then y g of a 10⁻² N hydrochloric acid solution are consecutively added to a previous mixture of A g of mercaptopropyltriethoxysilane [HS—CH₂)₃—Si(OEt)₃] and B g of a pre-condensate of dimethoxysilane, for which the recurrent unit is —Si(OCH₃)₂—O—.

After a reaction time of 10 hours at room temperature, the mixture of precursors is used (subsequently called a hydrolyzate) for the extrusion step with the poly(vinylidene fluoride-co-hexafluoropropene) copolymer (symbolized by PVDF-HFP) and a compatibilizing agent based on VDF and MAF.

The operating conditions of the pre-hydrolysis step for the different tests applied are listed in the table below (with x=y).

| Test | A (in g) | B (in g) | x and y (in g) |
|---|---|---|---|
| 1 | 4.73 | 5.27 | 1.43 |
| 2a, 2b, 2c and 2d | 9.52 | 1.61 | 1.35 |
| 3 | 10.31 | 3.67 | 1.34 |

The different hydrolyzates obtained from these tests are then applied for forming, according to the method of the invention, composite materials including functionalizing inorganic particles and compatibilized with the matrix.

The operating procedure is the following:

In a micro-extruder provided by DSM, provided with two conical screws and a flat die, 11.4 g of a PVDF-HFP copolymer, 0.6 g of a compatibilizing agent as well as the hydrolysates prepared beforehand are gradually incorporated, for which the characteristics in terms of ingredients appear in the table above.

The mixing is carried out at 190° C. for 15 minutes with a screw speed of 100 rpm. The material is then extracted at the outlet by means of a micro-calendering machine also provided by DSM. Finally, a film of a hybrid material is recovered with a thickness comprised between 20 and 100 μm.

The table below groups the different proportions (in % by mass based on the total mass of the mixture) of mercaptopropyltriethylsilane, of tetramethoxysilane pre-condensate and of compatibilizing agent (YP) applied for the different tests (the compatibilizing agent being respectively YP1 for test 1, YP1 for test 2a, YP2 for test 2b, YP3 for test 2c, YP1 for test 3).

| | PVDF-HFP | | Compound —SH | | Pre-condensate | | YP | |
|---|---|---|---|---|---|---|---|---|
| Test | m (g) | % m | m (g) | % m | m (g) | % m | m (g) | % m |
| 1 | 11.4 | 51.82 | 4.73 | 21.50 | 5.27 | 23.95 | 0.6 | 2.73 |
| 2a, | 11.4 | 49.29 | 9.52 | 41.16 | 1.61 | 6.96 | 0.6 | 2.59 |
| 2b, | | | | | | | | |
| 2c | | | | | | | | |
| 3 | 11.4 | 43.88 | 10.31 | 39.68 | 3.67 | 14.13 | 0.6 | 2.31 |
| 2d | 11.4 | 50.60 | 9.52 | 42.25 | 1.61 | 7.15 | 0 | 0 |

The table above groups the characteristics of the material in terms of mass percentages of —SH function, of functional inorganic particles as mentioned above and of non-functional silica particles.

| | PVDF-HFP + | | | | | | |
|---|---|---|---|---|---|---|---|
| | YP) | | | Non-functional | | Functional | |
| | (except for test | | | inorganic | | inorganic | |
| | 2d without YP) | Function —SH | | particles | | particles | |
| | Mass | Mass | Mass | Mass | Mass | Mass | Mass |
| Test | (in g) | (in g) | % | (in g) | % | (in g) | % |
| 1 | 12 | 2.52 | 14.40 | 4.01 | 22.91 | 5.50 | 31.42 |
| 2a, | 12 | 5.07 | 28.20 | 2.99 | 16.61 | 5.98 | 33.26 |
| 2b, | | | | | | | |
| 2c | | | | | | | |
| 3 | 12 | 5.49 | 28.07 | 4.32 | 22.09 | 7.57 | 38.67 |
| 2d | 11.4 | 5.07 | 29.17 | 2.99 | 17.20 | 5.98 | 34.41 |

The SH function mass corresponds to the mass of HS—CH₂—CH₂—CH₂—SiO_{3/2} created after hydrolysis-condensation reaction of mercaptopropyltriethoxysilane, i.e. corresponds to (A*127/238.42), A corresponding to the aforementioned mercaptopropyltriethoxysilane mass, 127 corresponding to the molar mass of HS—CH₂—CH₂—CH₂—SiO_{3/2} and 238.42 corresponding to the molar mass of mercaptopropyltriethoxysilane.

The mass percentage of —SH function is a mass percentage of SH based on the total mass of the final material. This mass percentage, after considering the hydrolysis-condensation reactions, is evaluated with the following formula:

%=(A*127/238.42)/[(A*127/238.42)+(B*60/106.2)+C+D]*100

wherein:
A, B, C and D respectively correspond to the masses of mercaptopropyltriethoxysilane (molar mass of 238.42), of pre-condensate (molar mass of 106.2), of PVDF-HFP and of compatibilizing agent; and
60 corresponds to the molar mass of SiO₂ from the hydrolysis-condensation of the pre-condensate.

The mass and the mass percentage of functional inorganic particles are determined in the following way.

Mass=(A*127/238.42)+(B*60/106.2)

%=[(A*127/238.42+B*60/106.2)]/[(A*127/238.42)+(B*60/106.2)+C+D]*100

The mass and the mass percentage of non-functional inorganic particles are determined in the following way.

Mass=(A*52/238.42)+(B*60/106.2)

%=[(A*52/238.42+B*60/106.2)]/[(A*127/238.42)+(B*60/106.2)+C+D]*100

52 corresponds to the molar mass of SiO_{3/2} from the hydrolysis-condensation reactions of the mercaptopropyltriethoxysilane compounds.

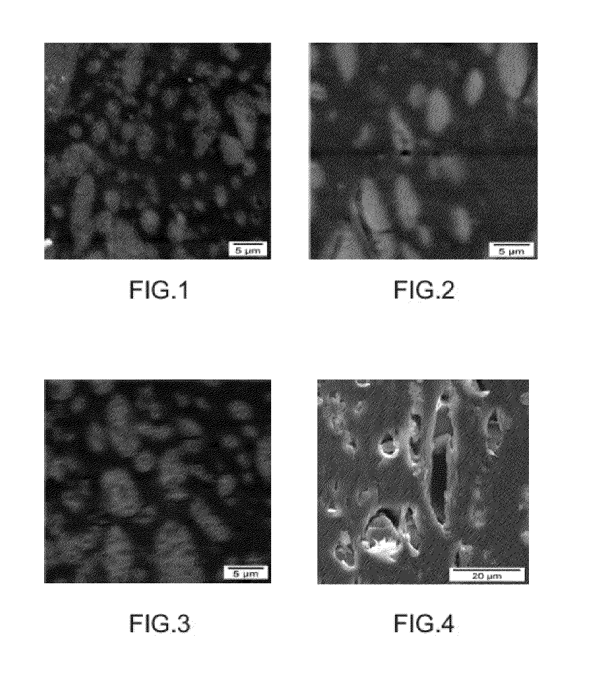

The behavior and the final properties of the obtained hybrid materials strongly depend on the morphology and therefore on the size of the fillers as well as of their dispersions within the polymeric matrix. The compatibilizing agents are used at 5% by mass based on PVDF-HFP. FIGS. 1 to 4 appended as an annex illustrate photographs of the materials respectively obtained from compatibilizing agents YP1, YP2 and YP3 (the materials being those respectively obtained according to the tests 2a, 2b and 2c), the last figure being a photograph of the material obtained without any compatibilizing agent (the material being the one obtained according to test 2d).

As regards FIGS. 1 to 3, it is clearly apparent that the inorganic particles forming the functional inorganic phase are organized in micro-domains. As for FIG. 4, it appears that these particles are organized in macro-domains.

### EXAMPLE 5

In order to test the possibility of applying the obtained materials according to the process of the invention as a fuel cell membrane, it was proceeded with chemical transformation of the —SH functions into —SO₃H in the aforementioned materials, for the materials referenced below as “YP1 material”, “YP2 material” and “YP3 material” (from the aforementioned tests 2a, 2b and 2c respectively).

In order to do this, these materials are treated by immersion in an oxidizing solution of hydrogen peroxide H₂O₂ at 50% by mass for 7 days at room temperature.

After 7 days of stirring, the materials are rinsed 3 times with permuted water and it is then proceeded with a fourth rinse for 24 hours, in order to remove the remainder of hydrogen peroxide and any forms of impurities.

The number of proton conducting sites is then determined further called ion exchange capacity (known under the acronym of IEC) by direct acid-base dosage. To do this, the materials are immersed in a 2M NaCl solution for 24 hours for total exchange of protons from the groups —SO₃H. The thereby obtained materials are then dried in vacuo for 24 hours at 60° C. before determining the dry mass thereof (said to be Mₛₐₘₚ).

The protons released into the solution are dosed by colorimetry (by using phenolphtalein) with a titrating solution of 0.05 M NaOH.

The IEC is then determined with the following formula:

IEC (in mequiv.g⁻¹)=(1000*C_{NaOH}*V_{NaOH})/Mₛₐₘₚ

wherein:

C_{NaOH} corresponds to the concentration of the soda solution;

V_{NaOH} corresponds to the volume of NaOH at equivalence; and

Mₛₐₘₚ corresponds to the dry mass of the material.

The ion exchange capacities obtained with the different materials tested appear in the table below.

| Material | IEC |
|---|---|
| Material YP1 | 1.26 |
| Material YP2 | 0.92 |
| Material YP3 | 0.95 |

The aforementioned materials all have a large ion exchange capacity, the values of which are of the same order of magnitude as those of Nafion®.

Furthermore, the morphology attained with the use of compatibilizing agents according to the definition of the invention gives the possibility of obtaining a percolated network of proton-conducting inorganic particles within the polymeric matrix.

1. A process for preparing a composite material comprising a fluorinated polymeric matrix and a filler consisting of ion exchange inorganic particles comprising a step for synthesizing in situ said particles within the polymeric matrix in the presence of a compatibilizing agent consisting of a copolymer comprising a first recurrent unit from the polymerization of a fluorinated ethylene monomer and a second recurrent unit from the polymerization of an optionally fluorinated (meth)acrylic monomer, said first recurrent unit being different from said second recurrent unit and said copolymer being different from the copolymer(s) entering the structure of the fluorinated polymeric matrix.

2. The process according to claim 1, wherein the in situ synthesis step is carried out in an extruder.

3. The process according to claim 1, wherein the in situ synthesis step is carried out with a sol-gel method.

4. The process according to claim 1, wherein the in situ synthesis step is carried out with a sol-gel method comprising the following operations:
an operation for putting the constitutive polymer(s) of the matrix, said compatibilizing agent in contact with one or several precursors of the inorganic particles, said precursor(s) fitting the following formula (I):
(X)_{y-n}-M-(R)ₙ (I)
wherein:
M is a metal element or a metalloid element;
X is a hydrolyzable chemical group;
R is an ion exchange chemical group or a precursor group of an ion exchange chemical group;
y corresponds to the valency of the element M; and
n is an integer ranging from 0 to (y-1);
a hydrolysis-condensation operation of said precursor(s), in return for which inorganic particles are obtained, resulting from the hydrolysis-condensation of said precursors;
in the case when R is a precursor group of an ion exchange chemical group, an operation for transforming the precursor group into an ion exchange chemical group or, in the case when n=0, an operation for functionalizing said particles with ion exchange chemical groups.

5. The process according to claim 1, wherein the in situ synthesis step is carried out with a sol-gel method comprising the following steps:
an operation for hydrolysis of one or several precursors of inorganic particles of the following formula (I):
(X)_{y-n}-M-(R)ₙ (I)
wherein:
M is a metal element or a metalloid element;
X is a hydrolyzable chemical group;
R is an ion exchange chemical group or a precursor group of an ion exchange chemical group;
y corresponds to the valency of element M; and
n is an integer ranging from 0 to (y-1);
an operation for putting the hydrolyzate obtained in the preceding step in contact with the constitutive polymer(s) of the matrix as well as the compatibilizing agent;
an operation for heating the resulting mixture to an effective temperature for generating transformation of the hydrolyzate into inorganic particles;
in the case when R is a precursor group of an ion exchange chemical group, an operation for transforming the precursor group into an ion exchange chemical group or, in the case when n=0, an operation for functionalizing said particles with ion exchange chemical groups.

6. The process according to claim 4, wherein M is silicon, titanium, aluminium, germanium, tin or lead.

7. The process according to claim 4, wherein X is an —OR′ group or a halogen atom, R′ representing an alkyl group.

8. The process according to claim 4, wherein R is a cation exchange group of formula —R²—Z¹, wherein:
R² is a simple bond, a linear or branched alkylene group, and optionally for which one or several hydrogen atoms are substituted with a halogen atom, such as fluorine, or R² is a cyclic hydrocarbon group;
Z¹ is a group —SO₃H, —PO₃H₂, —CO₂H, optionally as salts.

9. The process according to claim 4, wherein R is a group of formula —R²—Z³, wherein:
R² is a simple bond, a linear or branched alkylene group, and optionally for which one or several hydrogen atoms are substituted with a halogen atom, such as fluorine, or R² is a cyclic hydrocarbon group;
Z³ is a precursor group of a group Z′, wherein Z¹ is a group —SO₃H, —PO₃H₂, —CO₂H, optionally as salts.

10. The process according to claim 9, wherein the precursor is a precursor of the following formula (II):
(OR′)₄₋ₙ—Si—(R)ₙ (II)
wherein:
R′ is an alkyl group;
R corresponds to the formula —R²—Z³, R² being a linear or branched alkylene group, comprising from 1 to 30 carbon atoms, and optionally for which one or several hydrogen atoms are substituted with a halogen atom, and Z³ is a precursor group of a group Z¹, wherein Z¹ is a group —SO₃H, —PO₃H₂, —CO₂H, optionally as salts;
n is an integer ranging from 1 to 3.

11. The process according to claim 10, wherein the precursor is mercaptopropyltriethoxysilane of formula:
HS—(CH₂)₃—Si(OCH₂CH₃)₃

12. The process according to claim 4, wherein the precursor(s) are used in combination with a pre-condensate comprising a recurrent units of the following formula (III):
M(X)_{y-2} (III)
wherein:
M is a metal or metalloid element;
X is a hydrolyzable chemical group; and
y corresponds to the valency of element M.

13. The process according to claim 1, wherein the constitutive polymer(s) of the matrix are selected from among fluorinated thermoplastic polymers.

14. The process according to claim 13, wherein the fluorinated thermoplastic polymers are not ion exchange polymers selected from among polytetrafluoroethylenes (PTFE), polyvinylidene fluorides (PVDF), fluorinated ethylene propylene copolymers (FEP), copolymers of ethylene and tetrafluoroethylene (ETFE), copolymers of vinylidene fluoride and hexafluoropropene (PVDF-HFP), and mixtures thereof.

15. The process according to claim 1, wherein, for the compatibilizing agent, the first recurrent unit fits the following formula (V): 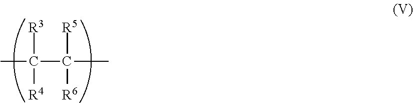
wherein R³, R⁴, R⁵ and R⁶ represent, independently of each other, a hydrogen atom, a halogen atom, a perfluoroalky group or a perfluoroalkoxy group, provided that at least one of the groups R³ to R⁶ represents a fluorine atom, a perfluoroalky group or a perfluoroalkoxy group.

16. The process according to claim 15, wherein a particular recurrent unit covered by the general definition of recurrent units of formula (V) corresponds to a recurrent unit of the following formula (VII):

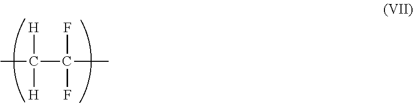

17. The process according to claim 1, wherein, for the compatibilizing agent, the second recurrent unit fits the following formula (IX): 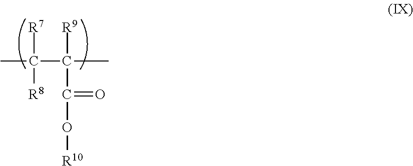
wherein:
R⁷ and R⁸ represent, independently of each other, a hydrogen atom, a halogen atom;
R⁹ represents a perfluoroalkyl group; and
R¹⁰ represents a hydrogen atom or a cationic counter-ion.

18. The process according to claim 17, wherein a particular recurrent unit covered by the general definition of recurrent units of formula (IX) corresponds to a recurrent unit of the following formula (X):

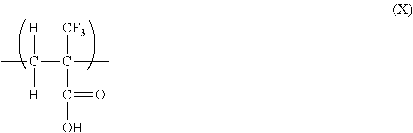

19. A composite material comprising a fluorinated polymeric matrix, at least one compatibilizing agent consisting of a copolymer comprising a first recurrent unit from the polymerization of a fluorinated ethylene monomer and a second recurrent unit from the polymerization of an optionally fluorinated (meth)acrylic monomer, said first recurrent unit being different from said second recurrent unit and said copolymer being different from the copolymer(s) entering the structure of the fluorinated polymeric matrix, and a filler consisting of ion exchange inorganic particles.
